(19) United States
(12) Patent Application Publication
(10) Pub. No.: US 2015/0227398 A1
(43) Pub. Date: Aug. 13, 2015

(54) ALLOCATING WORKLOADS BASED ON AIR FLOW PRIORITY

(71) Applicant: Hewlett-Packard Development Comapany, L.P., Houston, TX (US)

(72) Inventor: Matt Neumann, Roseville, CA (US)

(21) Appl. No.: 14/416,266

(22) PCT Filed: Sep. 27, 2012
(86) PCT No.: PCT/US2012/057548

§ 371 Date: Jan. 21, 2015

(51) Int. Cl. G06F 9/50

(52) U.S. Cl. CPC G06F 9/5094; G06F 9/5011

(57) ABSTRACT

Workloads can be assigned or allocated among multiple processing elements based on an air flow priority of the processing elements. In an example, the processing elements can be blade servers.

### BACKGROUND

Computing systems can have multiple processing elements. For example, a server system may include an enclosure that houses multiple blade servers. Workloads may be allocated among the processing elements. As the processing elements execute the workloads, the processing elements can heat up. Accordingly, computing systems often include cooling mechanisms, such as fans, for cooling the processing elements so that they do not overheat.

### BRIEF DESCRIPTION OF DRAWINGS

The following detailed description refers to the drawings, wherein:

FIG. 1 illustrates a computing system for allocating workloads based on air flow priority, according to an example.

FIG. 2 illustrates a blade server enclosure, according to an example.

FIG. 3 illustrates a method for assigning workload based on air flow priority, according to an example.

FIG. 4 illustrates a method for modifying air flow priorities, according to an example.

FIG. 5 illustrates a computer-readable medium for assigning workloads based on air flow priority, according to an example.

### DETAILED DESCRIPTION

According to an embodiment, a computing system with multiple processing elements can allocate workloads among the multiple processing elements based on air flow priority. In one example, the computing system can include an enclosure with multiple blade servers as the processing elements. The multiple blade servers may have different air flow characteristics based on their location within the enclosure and based on their proximity to a fan. An example air flow characteristic can be an air flow rate associated with the blade server or an amount of free space surrounding the blade server. Another air flow characteristic can be whether the fan is operating and the level at which the fan is operating. An air flow priority can be determined for each blade server. A workload allocator can allocate workloads to the blade servers based on the air flow priorities of the blade servers. By allocating workloads in this manner, power can be saved by reducing how often and at what level a fan is operated for cooling the blade servers.

In other examples, air flow priorities of the processing elements can be modified based on changing conditions. For example, the processing elements can be grouped into groups associated with one or more fans. When a fan is turned on for a particular group, the air flow priority of processing elements in that group can be increased since the fan results in a higher cooling capacity for the processing elements in the group. Additionally, the computing system can include a temperature sensor for each group to sense an ambient temperature of the group. When it is determined based on the sensed temperature that a fan is likely to be turned on or increased in level, the air flow priority of processing elements in that group can be modified to reflect this. For instance, the air flow priority can be increased since the imminent escalation of the fan can result in increased cooling capacity for the processing elements in the group. Alternatively, in some schemes the air flow priority may be decreased to reduce the likelihood that the fan would be escalated.

Further details and advantages of this embodiment and examples, as well as of other embodiments, will be discussed in more detail below with reference to the drawings.

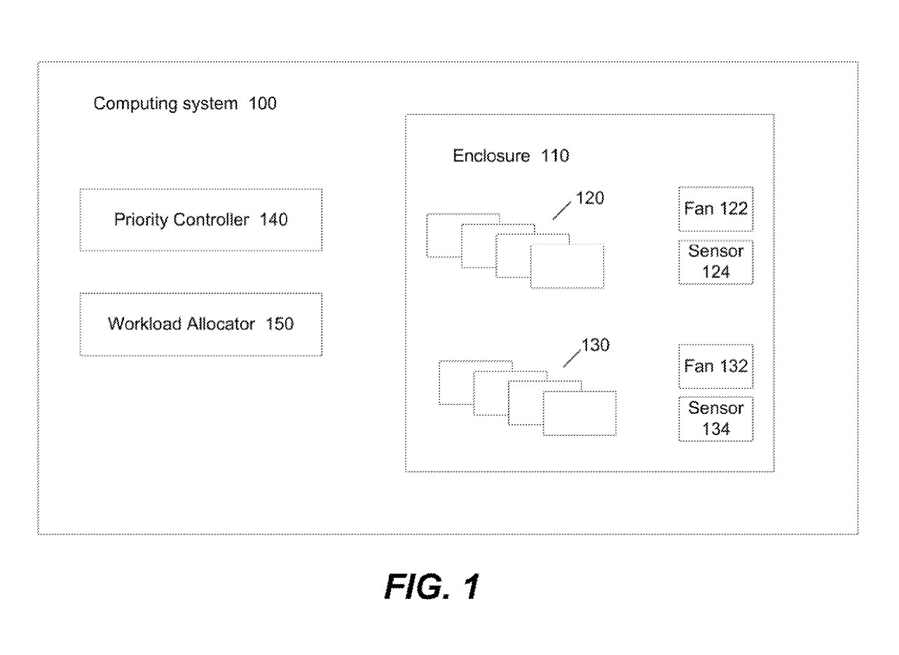

Referring now to the drawings, FIG. 1 illustrates a computing system for allocating workloads based on air flow priority, according to an example. Computing system 100 may include and/or be implemented by one or more computers. The computers may include one or more controllers and one or more machine-readable storage media.

A controller may include, a processor and a memory for implementing machine readable instructions. The priority controller 140 and workload allocator 150 include software modules, one or more machine-readable media for storing the software modules, and one or more processors for executing the software modules. A software module may be a computer program comprising machine-executable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

A controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable store e medium can be computer-readable and non-transitory. Additionally, computing system 100 may include one or more machine-readable storage media separate from the one or more controllers.

Computing system 100 may include enclosure 110. Enclosure 110 may be a housing to house multiple processing elements. Furthermore, enclosure 110 may include multiple groups of processing elements, such as processing element group 120 and processing element group 130. In one example, the processing elements may be blade servers. Furthermore, the processing elements may be controllers, as described above. Additionally, enclosure 110 may include more than one enclosure with multiple groups of processing elements.

Enclosure 110 may also include fans, such as fans 122 and 132. The fans may be configured to cool certain processing elements in the enclosure. For example, fan 122 may be configured to cool processing element group 120. Furthermore, fan 132 may be configured to cool processing element group 130. Fans 122 and 132 may be any of various fans used for cooling computer processing elements. For example, the fans may be axial-flow fans, centrifugal fans, or crossflow fans.

Computing system 100 may include priority controller 140 and workload allocator 150. Each of these components may be implemented by a single computer or multiple computers. In addition, users of computing system 100 may interact with computing system 100 through one or more other computers, which may or may not be considered part of computing system 100. As an example, a computer manager or technician may interact with computing system 100 via a user interface to manage its settings.

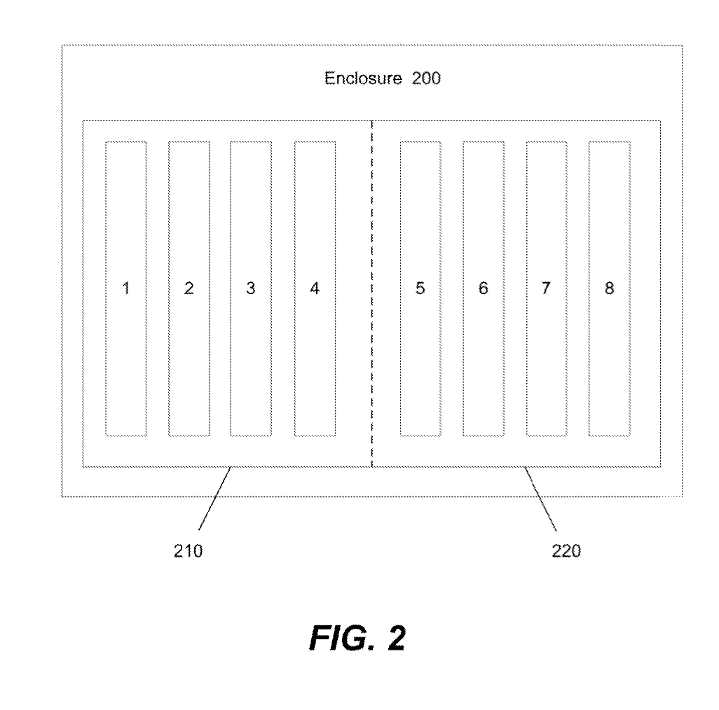

Priority controller 140 may be configured to prioritize each processing element in groups 120 and 130 based on air flow. To explain the concept of air flow and air flow priorities, reference is made to FIG. 2. FIG. 2 illustrates a blade server enclosure, according to an example. Enclosure 200 may house multiple blade servers 1-8. Blade servers 1-8 may be divided into two groups, group 210 and group 220. As can be seen, group 210 includes blade servers 1-4 and group 220 includes blade servers 5-8. Enclosure 200 may correspond to enclosure 110, group 210 may correspond to group 120, and group 220 may correspond to group 130.

Blade servers 1-8 in enclosure 200 may have different air flow characteristics due to the design of enclosure 200 and the placement of each blade server within the enclosure. Air flow characteristics may include a rate at which air flows over or around each blade server. This air flow rate can impact how quickly each blade server heats up as it performs a workload. The air flow rate can also impact the cooling capacity of each of the blade servers. The cooling capacity may indicate how quickly or efficiently a fan is able to cool the blade server. In addition, a location of the blade server relative to a location of a fan configured to cool the blade server may impact the cooling capacity. These air flow characteristics may be used to determine an air flow priority of each blade server. A high air flow priority may indicate positive air flow characteristics relative to the other blade servers while a low air flow priority may indicate negative air flow characteristics relative to the other blade servers. The priorities and/or the air flow characteristics may be stored on a computer readable storage medium accessible to priority controller 140 and workload allocator 150.

As an example, blade servers 4 and 5 may be initially set as having the highest air flow priority. In some enclosures, such as enclosure 200, blade servers located in the middle of the enclosure naturally have the highest air flow rate and cooling capacity. This can be due to the placement of fans within enclosure 200 as well as an amount of space surrounding blade servers 4 and 5. Air flow rate can be determined through manual or automated testing by measuring a volume of air flowing over or across each blade server using an airflow meter. This testing can be done prior to implementing computing system 100 and the measured values can be used to set an initial airflow priority for each blade server.

Conversely, blade servers 1 and 8 may be initially set as having the lowest air flow priority. in some enclosures, such as enclosure 200, blade servers located at the edge of the enclosure naturally have the lowest air flow rate and cooling capacity. This can be due to the placement of fans within enclosure 200, which placement may not favor blade servers 1 and 8, as well as because an amount of space surrounding blade servers 1 and 8 is less than the amount of space surrounding the other blade servers. These characteristics may result in poor air flow characteristics relative to the other blade servers and yield a poor air flow rate and cooling capacity.

For similar reasons as described above, blade servers 3 and 6 may have a next highest initial priority relative to blade servers 4 and 8, and blade servers 2 and 7 may have a next highest initial priority relative to blade servers 3 and 6.

Workload allocator 150 may be configured to allocate a workload to a blade server having highest priority. If there are multiple blade servers having highest priority, one of the highest priority blade servers may be selected based on any of various schemes. For example, one of the blade servers may be randomly selected, selected based on some other characteristic (e.g., an identification lumber, a group number, etc.), or the like. By allocating workloads to blade servers having a highest air flow priority, the amount of energy used by the fans of e computing system may be reduced. Applying this technique to a large datacenter with many enclosures and blade servers can thus yield significant cost and energy savings.

In an example, the priority controller 140 may be configured to prioritize groups of processing elements in addition to prioritizing the processing elements themselves. For instance, a first group of processing elements may be prioritized over another group of processing elements if the air flow characteristics of the first group change in a positive way. One way the air flow characteristics of a group may change is by activating a fan configured to cool the group's processing elements or escalating a level at which that fan is operating. For example, if fan 122 for group 120 is turned on while fan 132 for group 130 is turned off, the cooling capacity of group 120 increases over that of group 130. As a result, the processing elements of group 120 can perform a higher workload than the processing elements of group 130 due to the increased cooling from the operating fan 122.

Accordingly, workload a locator 150 may be configured to allocate a workload to a blade server within a group of higher priority. For example, if group 120 is prioritized over group 130 due to the operation of fan 122, workload allocator 150 may allocate a workload to a processing element in group 120 instead of processing element in group 130. This may occur even though the highest priority available processing element in group 120 is lower than the highest priority available processing element in group 130. For instance, referring to FIG. 2, assume that group 210 has a higher priority than group 220. Also assume that the only available blade server in group 210 is blade server 1, while blade server 5 in group 220 is available. Due to the higher priority of group 210, workload allocator may place the workload with blade server 1 instead of with blade server 5. On the other hand, if a group has no available blade servers, that group's priority may be reduced, ignored, or the like, so that workloads are placed with other groups.

Computing system 100 may also include a sensor 124, 134 for each group 120, 130, such as a temperature sensor. The temperature sensor may be configured to sense an ambient temperature of air surrounding the processing elements in the group. The sensed temperature may be used to trigger the group's fan to turn on or to escalate to a higher level. Accordingly, the sensed temperature can be indicative of whether a fan in the group is likely to turn on or escalate. As a result, the priority controller 140 can be configured to prioritize a group whose sensed temperature indicates that the fan is close to turning on or escalating, which may increase the cooling capacity of that group.

In an example, workload allocator 150 may be configured to reallocate a workload from one processing element to another. For instance, if a higher priority processing element becomes available in the same group, a workload may be moved from a lower priority processing element to the higher priority processing element, Similarly, a workload can be moved from a processing element in a first group to a processing element in a second group for various reasons. For example, if a sensed temperature indicates that a fan for the first group is close to turning on, a workload can be moved from the first group to the second group if the second group has a higher priority (and thus higher cooling capacity). This can prevent a fan from being turned on while still executing the workload.

The above prioritization and allocation schemes are merely examples. By taking advantage of known air flow characteristics as described, various prioritization and allocation schemes may be implemented to efficiently manage workloads while reducing power consumption from fans and other cooling mechanisms.

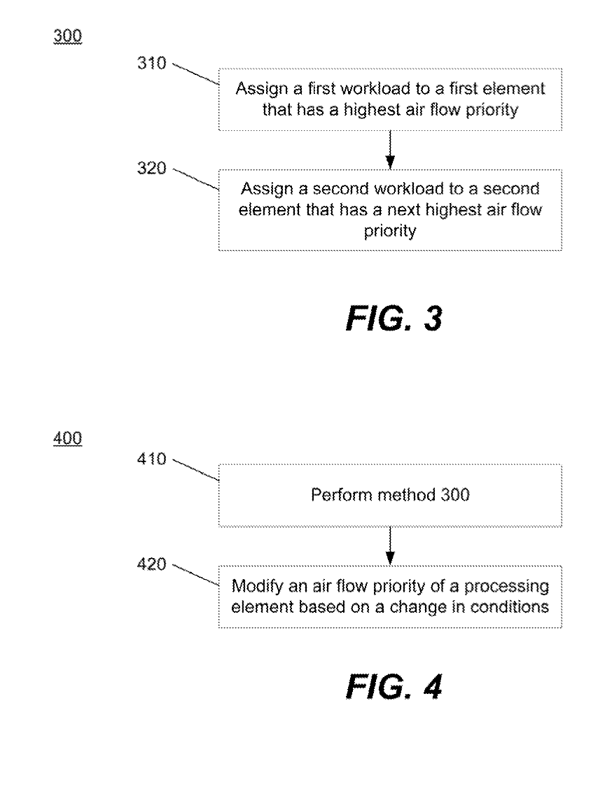

FIGS. 3-5 depict methods and a computer for implementing workload assignment and allocation based on air flow priorities. In the interest of conciseness, repetition of the details above is avoided. Accordingly, the details described above are meant to enrich these embodiments and examples.

FIG. 3 illustrates a method for assigning workloads based on air flow priority, according to an example. Method 300 may be implemented by a computing system, such as computing system 100. At 310, a first workload can be assigned to a first processing element that has a highest air flow priority. At 320, a second workload can be assigned to a second processing element that has a next highest air flow priority,

FIG. 4 illustrates a method for modifying air flow priorities, according to an example. Method 400 may be implemented by a computing system, such as computing system 100. At 410, the method 300 may be performed. At 420, the air flow priority of a processing element may be modified based on a change in conditions. The change in conditions may influence the air flow characteristics of the processing element. As examples, the air flow priority may be modified based on whether a fan assigned to cool the processing element is running, based on a level at which the fan assigned to cool the processing element is running, and/or based on a temperature sensed by a temperature sensor associated with the processing element.

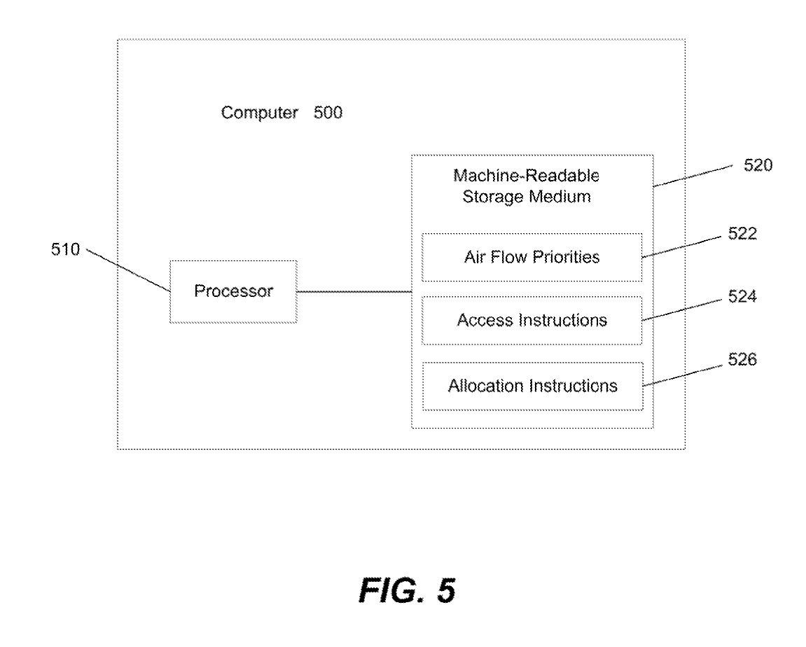

FIG. 5 illustrates a computer-readable medium for assigning workloads based on air flow priority, according to an example. Computer 500 may comprise multiple computing devices or systems, such as described with respect to computing system 100.

Processor 510 may be at least one central processing unit (CPU), at least one semiconductor-based microprocessor, other hardware devices or processing elements suitable to retrieve and execute instructions stored in machine-readable storage medium 520, or combinations thereof. Processor 510 can include single or multiple cores on a chip, multiple cores across multiple chips, multiple cores across multiple devices, or combinations thereof. Processor 510 may fetch, decode, and execute instructions 524, 526, among others, to implement various processing. As an alternative or in addition to retrieving and executing instructions, processor 510 may include at least one integrated circuit (IC), other control logic, other electronic circuits, or combinations thereof that include a number of electronic components for performing the functionality of instructions 524, 526, Accordingly, processor 510 may be implemented across multiple processing units and instructions 524, 526 may be implemented by different processing units in different areas of computer 500.

Machine-readable storage medium 520 may be any electronic, magnetic, optical, or other physical storage device that contains or stores executable instructions. Thus, the machine-readable storage medium may comprise, for example, various Random Access Memory (RAM), Read Only Memory (ROM) flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 520 can be computer-readable and non-transitory. Machine-readable storage medium 520 may be encoded with a series of executable instructions for managing processing elements.

The instructions 524, 526, when executed by processor 510 (e.g., via one processing element or multiple processing elements of the processor) can cause processor 510 to perform processes, for example, the processes depicted in FIGS. 3 and 4 and described with respect to FIGS. 1 and 2. Furthermore, computer 500 may be similar to computing system 100 and may have similar functionality and be used in similar ways, as described above.

Access instructions 624 can cause processor 510 to access air flow priorities 522 associated with multiple blade servers of an enclosure. Allocation instructions 526 can cause processor 510 to allocate workloads to the multiple blade servers based on the air flow priorities. For example, an available blade server with a highest priority may receive a given workload. The air flow priorities 522 may be modified based on changes in conditions. For example, an air flow priority of a given blade server may be modified based on a level at which a fan associated with the blade server is running. Additionally, an air flow priority of a given blade server may be modified based on a temperature sensed by a temperature sensor associated with each blade server.

What is claimed is:

1. A computing system, comprising:
a plurality of blade servers, the blade servers divided into at least two groups;
a plurality of fans, at least one fan for each group of blade servers;
a priority controller to prioritize each blade server based on air flow; and
a workload allocator to allocate a workload to a blade server having highest priority.

2. The computing system of claim 1, wherein the priority controller is configured to prioritize each group based on whether a fan is running in the group and whether the group has a blade server free to do work, wherein the workload allocator is configured to allocate a workload to a blade server within a group of higher priority.

3. The computing system of claim 1, wherein the priority controller is configured to prioritize each group based on a level at which the fan for the group is running and whether the group has a blade server free to do work.

4. The computingg system of claim 1, further comprising a computer-readable storage medium storing air flow characteristics of each blade server.

5. The computing system of claim 1, wherein the workload allocator is configured to allocate a workload to a blade server of lower priority in a first group over a blade server of higher priority in a second group if the first group has a higher priority than the second group.

6. The computing system of claim 1, further comprising a temperature sensor for each group of blade servers, wherein the priority controller is configured to prioritize a group if the group's temperature sensor indicates that the group's fare is close to turning on or to escalating to a higher level of operation.

7. The computing system of claim 6, wherein the workload allocator is configured to reallocate a workload assigned to a first group to a second group if the priority of the second group is increased and the temperature sensor of the first group indicates that the first group's fan is close to turning on or to escalating to a higher level of operation.

8. A method, comprising:
assigning a first workload to a first processing element of a group of processing elements that has a highest air flow priority; and
assigning a second workload to a second processing element the group of processing elements that has a next highest air flow priority.

9. The method of claim 8, further comprising modifying an air flow priority of a processing element based on whether a fan assigned to cool the processing element is running.

10. The method of claim 9, further comprising modifying the air flow priority of a processing element based on a level at which the fan assigned to cool the processing element is running.

11. The method of claim 9, further comprising modifying the air flow priority of a processing element based on a temperature sensed by a temperature sensor associated with the processing element.

12. The method of claim 8, wherein the first processing element is a member of a first subset of the group of processing elements and the second processing element is a member of a second subset of the group of processing elements, the method further comprising reassigning the second workload to a third processing element that is a member of the first subset if a fan associated with the first subset is turned on or is escalated to a higher level of operation.

13. A non-transitory computer-readable storage medium comprising instructions that, when executed by a processor, cause the processor to:
access air flow priorities of multiple blade servers of an enclosure; and
allocate workloads to the multiple blade servers based on the air flow priorities, wherein a blade server with a highest priority receives a workload.

14. The computer-readable medium of claim 13, further comprising instructions that, when executed by the processor cause the processor to modify the air flow priorities based on a level at which a fan associated with each blade server is running.

15. The computer-readable medium of claim 14, further comprising instructions that, when executed by the processor cause the processor to modify the air flow priorities based on a temperature sensed by a temperature sensor associated with each blade server.
